(19) United States
(12) Patent Application Publication
(10) Pub. No.: US 2012/0133545 A1
(43) Pub. Date: May 31, 2012

(54) COLLISION AVOIDANCE TRANSPONDER FOR AERIAL HAZARDS AND METHOD FOR REDUCING COLLISIONS WITH AERIAL HAZARDS

(75) Inventors: Thomas J. Fagan, Tucson, AZ (US); Carl G. Foster, Tucson, AZ (US)

(73) Assignee: Raytheon Company, Waltham, MA (US)

(21) Appl. No.: 12/955,973

(22) Filed: Nov. 30, 2010

(51) Int. Cl. G01S 13/93

(52) U.S. Cl. 342/30

(57) ABSTRACT

Embodiments of a collision-avoidance transponder and method for reducing collisions with an aerial hazard are generally described herein. The collision-avoidance transponder may be configured for location on an aerial hazard and may be configured to regularly transmit a signal that mimics an air traffic control (ATC) transponder reply signal. The regularly-transmitted signal may include an altitude indication, such as the pressure altitude, of the aerial hazard. A collision-avoidance and warning system on an aircraft may receive the regularly-transmitted signal and provide a warning under certain conditions to allow the pilot to avoid the aerial hazard. The collision-avoidance transponder may include an ATC-type transponder and control circuitry to cause the transponder to regularly transmit the signal that includes a pressure altitude of the aerial hazard.

### TECHNICAL FIELD

Embodiments pertain to air-navigation and avoiding collisions with aerial hazards. Some embodiments relate to air-traffic control (ATC) transponders.

### BACKGROUND

A major safety issue with air navigation is avoiding collisions with aerial hazards. This is particularly a concern for helicopters and small aircraft that navigate in and around locations that include both permanent and temporary aerial hazards. For example, emergency response helicopters may need to navigate in regions with construction cranes, radio towers, guy wires and bridges when responding to emergency situations. Pilots associations are interested in solutions to avoid collisions with these types of aerial hazards since many helicopters have crashed while responding to emergency situations. Although a pilot may be informed of the location of an aerial hazard prior to flight or may have seen an aerial hazard on a prior flight, a pilot cannot be expected to rely on memory to remember their specific location, particularly since the location of some of these hazards may change (e.g., a construction crane may be moved on a daily or weekly basis). Furthermore, direct vision is generally not sufficient to avoid collisions with these hazards, and because of the expense, not all aircraft are equipped with sophisticated collision avoidance systems.

Thus, there are general needs for systems and methods that may help reduce collisions with aerial hazards. There are also general needs for systems and methods that may help reduce collisions with aerial hazards that are inexpensive, do not require modification to current aircraft equipment, and do not require any additional equipment on an aircraft.

### BRIEF DESCRIPTION OF THE DRAWINGS

FIG. 1 is a functional diagram of a collision-avoidance transponder in accordance with some embodiments; and

FIG. 2 illustrates the operational environment of the collision-avoidance transponder of FIG. 1, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In accordance with some embodiments, collisions with an aerial hazard may be reduced by regularly transmitting a signal that mimics an air traffic control transponder reply signal from the aerial hazard. The signal may include an altitude indication of the aerial hazard. The altitude indication of the aerial hazard may be a pressure altitude. A collision-avoidance and warning system on an aircraft that receives the regularly-transmitted signal may provide to a pilot a warning based on a difference between the altitude indication received in the regularly transmitted signal and the altitude of the aircraft.

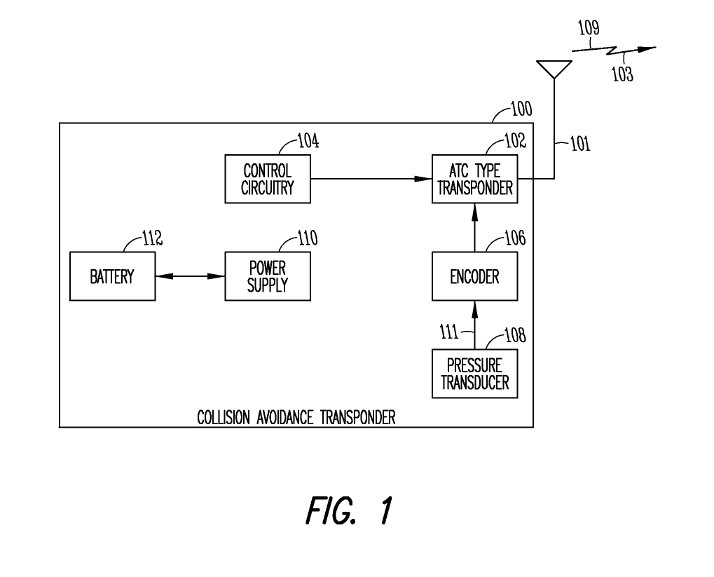

FIG. 1 is a functional diagram of a collision-avoidance transponder in accordance with some embodiments. Collision-avoidance transponder 100 may be configured for location on an aerial hazard and may be configured to regularly transmit a signal 103 that mimics an air traffic control transponder reply signal. The regularly-transmitted signal 103 may include an altitude indication 109 of the aerial hazard. The collision-avoidance transponder 100 may include an air-traffic control (ATC) type transponder 102 and control circuitry 104 to cause the ATC type transponder 102 to regularly transmit the signal 103 that includes the altitude indication 109 of the aerial hazard. The ATC type transponder 102 may be similar to an ATC transponder or may comprise a modified ATC transponder.

The collision-avoidance transponder 100 may also include a pressure transducer 108 to generate an output 111 indicative of the elevation or altitude (e.g., a pressure altitude) of the aerial hazard. The collision-avoidance transponder 100 may include an altitude encoder 106 to encode the output 111 from the pressure transducer 108 to generate an encoded altitude indication (e.g., an encoded pressure altitude) for inclusion in the regularly-transmitted signal 103. The collision-avoidance transponder 100 may also include a power supply 110 to supply power to the various elements of the collision-avoidance transponder 100. The power may be supplied from a battery 112, although this is not a requirement as the collision-avoidance transponder 100 may be configured to be powered by other sources.

The collision-avoidance transponder 100 may also include one or more antennas 101 for use in transmitting the regularly-transmitted signal 103. The one or more antennas 101 may include an omnidirectional antenna, including, for example, a dipole antenna, a monopole antenna, a patch antenna, a microstrip antenna, or other type of antenna suitable for transmission of vertically-polarized UHF signals. In some embodiments, antenna 101 may be a single omnidirectional antenna similar to or having the same gain as an antenna used for an ATC transponder in an aircraft.

Although the collision-avoidance transponder 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. The functional elements of the collision-avoidance transponder 100 illustrated in FIG. 1 may refer to one or more processes operating on one or more processing elements.

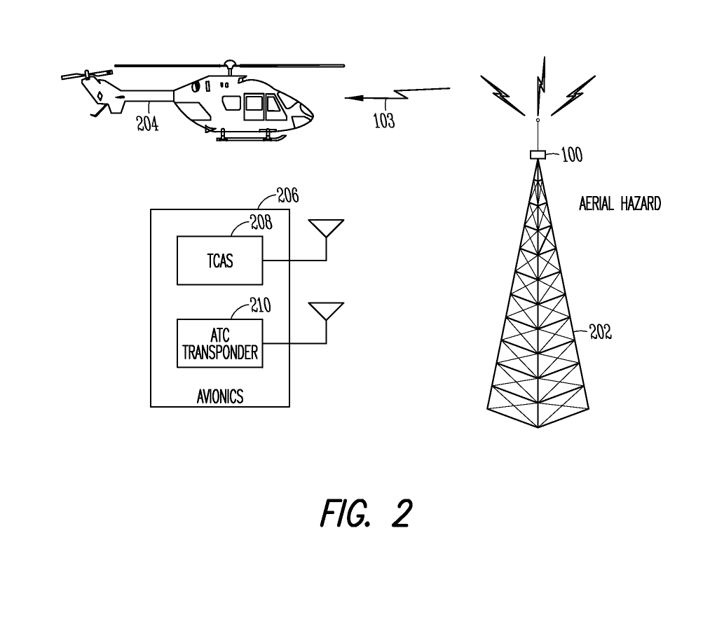

FIG. 2 illustrates the operational environment of the collision-avoidance transponder 100 of FIG. 1 in accordance with some embodiments. The collision-avoidance transponder 100 is illustrated in FIG. 2 as being located on top of aerial hazard 202. The collision-avoidance transponder 100 may be configured to regularly transmit the signal 103 that mimics an ATC transponder reply signal. As discussed above, the regularly-transmitted signal 103 may include the altitude indication 109 (FIG. 1) of the aerial hazard 202. An aircraft, such as aircraft 204, may receive the regularly-transmitted signal 103, and a collision-avoidance and warning system 208 on the aircraft 204 may process the regularly-transmitted signal 103 and provide a warning under certain conditions to allow the pilot to avoid the aerial hazard 202.

The collision-avoidance transponder 100 may be configured to regularly transmit signal 103 regardless of whether or not the collision-avoidance transponder 100 is interrogated. In these embodiments, the regularly-transmitted signal 103 is transmitted regularly, even though no interrogation signal is received. From the perspective of the collision-avoidance and warning system 208 on the aircraft 204, the regularly-transmitted signal 103 will appear as a reply to an ATC radar interrogation signal even though no interrogation may have occurred.

In some embodiments, the collision-avoidance transponder 100 may also be configured to transmit a reply signal including an altitude indication 109 in response to receipt of an interrogation signal. In these embodiments, the reply signal may be similar to or identical to the regularly-transmitted signal 103. The reply signal may be an ATC reply signal as described in more detail below.

The regularly-transmitted signal 103 may be transmitted on a predetermined frequency or frequency channel, which may depend on the jurisdiction. The regularly-transmitted signal 103 may be an amplitude-modulated (AM) signal that is transmitted on a UHF frequency, such as 1090 MHz, although the scope of the embodiments is not limited in this respect.

In some embodiments, the control circuitry 104 (FIG. 1) may be configured to cause the ATC type transponder 102 (FIG. 1) to regularly transmit signal 103 once every time period. The time period may range between one and ten seconds. In some embodiments, the time period may be less than one second, while in other embodiments, the time period may be greater than ten seconds. The regularly-transmitted signal 103 may also be transmitted periodically.

The regularly-transmitted signal 103 may be configured as a Mode-C reply configured in accordance with a Federal Aviation Administration (FAA) Technical Service Order (TSO). In this way, the regularly-transmitted signal 103 may mimic an ATC transponder reply signal. In these embodiments, the FAA Mode-C reply may be transmitted regularly by the collision-avoidance transponder 100 whether or not the transponder 100 receives an ATC radar interrogation signal. The collision-avoidance transponder 100 may also transmit a FAA Mode-C reply in response to an interrogation signal such as an ATC radar interrogation, although the scope of the embodiments is not limited in this respect. The Mode-C reply may be configured in accordance with FAA TSO C74c or other equivalent TSO.

The altitude indication 109 of the aerial hazard 202 may be a pressure altitude, which may be an absolute pressure. The altitude of the aerial hazard 202 may be directly determined from the pressure altitude or the absolute pressure. The output 111 (FIG. 1) generated by the pressure transducer 108 (FIG. 1) may be used by the collision-avoidance transponder 100 to generate the altitude indication or pressure altitude of the aerial hazard 202 for inclusion in the regularly-transmitted signal 103.

Although the pressure transducer 108 (FIG. 1) is shown as being within the collision-avoidance transponder 100, this is not a requirement, as the pressure transducer 108 may be located separately at or near the top of an aerial hazard 202 to measure the pressure altitude at or near the top of the aerial hazard 202. In these embodiments, the other elements of the collision-avoidance transponder 100 may be located elsewhere. The pressure transducer 108 may be standard aircraft pressure transducer, although this is not a requirement.

The altitude encoder 106 (FIG. 1) may be a gray-code encoder. In these embodiments, the gray-code encoder may be configured to encode the output 111 from the pressure transducer 108 with a gray code to generate an encoded pressure altitude for inclusion in the regularly-transmitted signal 103.

Because the regularly-transmitted signal 103 may be specifically configured for receipt by collision-avoidance and warning systems of aircraft, such as collision-avoidance and warning system 208 of aircraft 204, the collision-avoidance and warning system 208 may provide a warning when a difference between the pressure altitude indicated by the regularly-transmitted signal 103 and a pressure altitude of the aircraft 204 is less than an altitude threshold. For example, the collision-avoidance and warning system 208 may emit a warning to the pilot when the difference between the pressure altitudes indicates less than approximately 500 feet of vertical separation, although the scope of the embodiments is not limited in this respect. In other words, a warning may be provided when the aircraft 204 is within 500 feet in altitude of aerial hazard 202. The warning may be provided when the aircraft 204 is also within a predetermined lateral distance from the aerial hazard 202. The warning, for example, may be an audible and/or visual alarm.

The collision-avoidance and warning system 208 of the aircraft 204 may also be configured to calculate an approximate lateral distance to the aerial hazard 202 based on a received signal level of the regularly-transmitted signal 103. In these embodiments, the regularly-transmitted signal 103 may be transmitted at a predetermined effective radiated power level to allow the collision-avoidance and warning system 208 to calculate an approximate lateral distance to the aerial hazard 202. In these embodiments, the collision-avoidance and warning system 208 of the aircraft 204 may be able to approximate the distance to within a mile or less of the aerial hazard 202. The approximated lateral distance as well as the elevation difference may be indicated to a pilot of the aircraft 204. A warning may be provided when the aircraft 204 is within a predetermined lateral distance and elevation from the aerial hazard 202.

The collision-avoidance and warning system 208 may be a standard traffic collision avoidance system (TCAS), although this is not a requirement. In addition to the collision-avoidance and warning system 208, the aircraft avionics 206 may also include a standard ATC transponder 210 that is responsive to interrogation signals (e.g., from ATC radar) to provide, among other things, the pressure altitude of the aircraft 204 in response to being interrogated by an ATC radar.

The collision-avoidance transponder 100 may also be configured to regularly transmit signal 103 in response to an interrogation signal that may be transmitted by the collision-avoidance and warning system 208 of the aircraft 204. The collision-avoidance and warning system 208 may be configured to determine an approximate distance to the aerial hazard 202 based on the time of receipt of the reply signal (e.g., based on round-trip delay and processing time). Unlike the use of signal levels or signal strength, in these embodiments, a more accurate lateral distance to the aerial hazard 202 may be determined by an aircraft that is configured to transmit interrogation signals.

The aerial hazard 202 may be at least one-hundred feet above a ground level, and the collision-avoidance transponder 100 may be designed to operate when subjected to the environmental conditions experienced by the aerial hazard 202. In these embodiments, the collision-avoidance transponder 100 may be ruggedized to handle extreme heat and extreme cold as well as snow, rain and other weather conditions at the top of an aerial hazard 202.

In accordance with embodiments, the aerial hazard 202 may include both permanently located obstacles or aerial hazards (e.g., radio towers, guy wires, buildings, power lines, bridges, mountain tops) and temporally located obstacles or aerial hazards (e.g., construction cranes). An aerial hazard 202 may include any location that is greater than one hundred feet above the ground level, although the scope of the embodiments is not limited in this respect as the collision-avoidance transponder 100 may be located on obstacles of almost any height. As used herein, the terms ‘obstacles’ and ‘aerial hazards’ do not include aircraft. The altitude indication 109 that is transmitted as part of the regularly-transmitted signal 103 may be an indication of the altitude (e.g., the pressure altitude) of the highest point on the aerial hazard 202.

The collision-avoidance transponder 100 may be configured for locations on aerial hazards 202 that do not have a source of power. In these embodiments, the collision-avoidance transponder 100 may be configured for battery power (i.e., via battery 112 (FIG. 1)). Battery 112 may comprise one or more conventional batteries, although this is not a requirement as many other types of batteries may be suitable. In other embodiments, the collision-avoidance transponder 100 may be configured to receive power from a conventional power source when available at the location of the aerial hazard 202. In these embodiments, the collision-avoidance transponder 100 may be provided with a battery backup in the event that the power from the power source becomes unavailable.

Embodiments may be implemented in one or a combination of hardware, firmware and software. In these embodiments, the control circuitry 104 and portions of the ATC-type transponder 102 may be configured to implement instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. The control circuitry 104 and the ATC-type transponder 102 may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A collision-avoidance transponder for location on an aerial hazard configured to regularly transmit a signal that mimics an air traffic control transponder reply signal, the signal including an altitude indication of the aerial hazard.

2. The collision-avoidance transponder of claim 1 wherein the altitude indication of the aerial hazard is a pressure altitude, and
wherein the collision-avoidance transponder is configured to regularly transmit the signal that includes the altitude indication regardless of whether or not the collision-avoidance transponder is interrogated.

3. The collision-avoidance transponder of claim 2 wherein the collision-avoidance transponder is further configured to transmit a signal that includes the altitude indication in response to receipt of an interrogation signal.

4. The collision-avoidance transponder of claim 2 further comprising:
an air-traffic control (ATC) transponder; and
control circuitry to configure the ATC transponder to regularly transmit the signal that includes the altitude indication.

5. The collision-avoidance transponder of claim 4 wherein the control circuitry is configured to cause the ATC transponder to regularly transmit the signal that includes the altitude indication once every time period, and
wherein the time period ranges between one and ten seconds.

6. The collision-avoidance transponder of claim 5 wherein the regularly-transmitted signal that includes the altitude indication is a Mode-C reply configured in accordance with a Federal Aviation Administration (FAA) Technical Service Order (TSO).

7. The collision-avoidance transponder of claim 6 further comprising:
a pressure transducer to generate an output indicative of the pressure altitude of the aerial hazard; and
an altitude encoder to encode the output from the pressure transducer to generate an encoded pressure altitude for inclusion in the regularly-transmitted signal.

8. The collision-avoidance transponder of claim 2 wherein the regularly-transmitted signal that includes the altitude indication is configured for receipt by a collision-avoidance and warning system on an aircraft, and
wherein the collision-avoidance and warning system of the aircraft is configured to provide a warning when a difference between the pressure altitude indicated by the regularly-transmitted signal and a pressure altitude of the aircraft is less than an altitude threshold.

9. The collision-avoidance transponder of claim 8 wherein the regularly-transmitted signal that includes the altitude indication is transmitted at a predetermined signal level, and
wherein the collision-avoidance and warning system of the aircraft is further configured to calculate an approximate distance to the aerial hazard based on a signal level of the regularly-transmitted signal that includes the altitude indication received from the collision-avoidance transponder.

10. The collision-avoidance transponder of claim 9 wherein the collision-avoidance transponder is further configured to transmit the signal including the altitude indication of the aerial hazard in response to an interrogation signal transmitted by the collision-avoidance and warning system of the aircraft, and
wherein the collision-avoidance and warning system of the aircraft is configured to determine an approximate distance to the aerial hazard based on a time of receipt of the air traffic control transponder reply signal.

11. The collision-avoidance transponder of claim 1 further comprising a power supply to supply power to the collision-avoidance transponder from a battery.

12. A collision-avoidance transponder for location on an aerial hazard comprising:
an air-traffic control (ATC) transponder;
control circuitry to cause the ATC transponder to regularly transmit a signal that includes a pressure altitude of the aerial hazard; and
a pressure transducer to provide the pressure altitude for transmission as part of the regularly-transmitted signal.

13. The collision-avoidance transponder of claim 12 wherein the regularly-transmitted signal that includes the pressure altitude is a reply signal that is configured for receipt by a collision-avoidance and warning system on an aircraft, and
wherein the control circuitry is configured to cause the ATC transponder to regularly transmit the signal that includes the pressure altitude regardless of whether or not the collision-avoidance transponder is interrogated.

14. The collision-avoidance transponder of claim 13 wherein the regularly-transmitted signal that includes the pressure altitude is a Mode-C reply configured in accordance with a Federal Aviation Administration (FAA) Technical Service Order (TSO).

15. The collision-avoidance transponder of claim 12 wherein the control circuitry is configured to cause the ATC transponder to regularly transmit the signal that includes the pressure altitude once every time period ranging between one and ten seconds.

16. A method for reducing collisions with an aerial hazard comprising:
regularly transmitting a signal that mimics an air traffic control transponder reply signal from the aerial hazard, the signal including an altitude indication of the aerial hazard.

17. The method of claim 16 wherein the altitude indication of the aerial hazard is a pressure altitude,
wherein the signal that includes the altitude indication is regularly transmitted regardless of whether or not the collision-avoidance transponder is interrogated, and
wherein a collision-avoidance and warning system on an aircraft that receives the regularly-transmitted signal is configured to provide a warning when a difference between the pressure altitude and a pressure altitude of the aircraft is less than an altitude threshold.

18. The method of claim 17 wherein the signal that mimics an air traffic control transponder reply signal is transmitted at a predetermined signal level to allow the collision-avoidance and warning system on the aircraft to approximate a lateral distance to the aerial hazard.

19. The method of claim 16 further comprising transmitting the signal that includes the altitude indication in response to receipt of an interrogation signal.

20. The method of claim 16 wherein the signal that includes the altitude indication is regularly transmitted once every time period, and
wherein the time period ranges between one and ten seconds.

21. The method of claim 20 wherein the regularly-transmitted signal that includes the altitude indication is a Mode-C reply configured in accordance with a Federal Aviation Administration (FAA) Technical Service Order (TSO).

22. A method of reducing collisions with aerial hazards comprising:
placing a collision-avoidance transponder on each of a plurality of one or more aerial hazards; and
regularly transmitting a signal that mimics an air traffic control transponder reply signal from the collision-avoidance transponder of each aerial hazard, each transmitted signal including an encoded pressure altitude of the associated aerial hazard,
wherein collision-avoidance and warning systems on aircraft that receive the regularly-transmitted signal are configured to provide a warning when a difference between the encoded pressure altitude indicated in one of the regularly-transmitted signals and a pressure altitude of the aircraft is less than an altitude threshold.

23. The method of claim 22 wherein the regularly-transmitted signal is configured as a Mode-C reply configured in accordance with a Federal Aviation Administration (FAA) Technical Service Order (TSO) that is transmitted once every time period ranging between one and ten seconds.
